(19) United States
(12) Patent Application Publication
(10) Pub. No.: US 2025/0269447 A1
(43) Pub. Date: Aug. 28, 2025

(54) LONG-LIFE ANNULAR WALL CUTTING MACHINE

(71) Applicant: ZHEJIANG TICHOP TOOLS CO., LTD., Jinhua City (CN)

(72) Inventors: WEI WANG, Jinhua City (CN); YA-QI WANG, Jinhua City (CN)

(21) Appl. No.: 18/991,691

(22) Filed: Dec. 22, 2024

(30) Foreign Application Priority Data
Feb. 22, 2024 (CN) 202420326910.8
Feb. 22, 2024 (CN) 202420327850.1
Feb. 22, 2024 (CN) 202420328057.3

(51) Int. Cl. B23D 61/08

(52) U.S. Cl. CPC B23D 61/08

(57) ABSTRACT

The disclosure discloses a long-life annular wall cutting machine, relating to the technical field of wall cutting machines. The technical solution is as follows: The long-life annular wall cutting machine includes an annular saw blade fixing and protecting cover assembly. A power wheel is arranged in the annular saw blade fixing and protecting cover assembly, an annular saw blade is arranged in a middle of the power wheel, and the power wheel and the annular saw blade abut against each other. In the disclosure, by rotating a tensioning handwheel, a contact strength between the annular saw blade and the power wheel can be adjusted, thereby realizing optimized adjustment of the power wheel.

### FIELD OF THE INVENTION

The disclosure relates to the technical field of wall cutting machines, and in particular to a long-life annular wall cutting machine.

### BACKGROUND OF THE INVENTION

A wall cutting machine, which is an apparatus for cutting walls, is often used in construction and decoration industries. The wall cutting machine can cut the walls rapidly and accurately, so as to improve the working efficiency and reduce the labor cost. During the cutting operation of the machine, a brushless motor needs to be driven by a motor driver. During the operation of the driver, power elements generate a lot of heat. If the heat of the heating elements cannot be effectively dissipated, it is prone to thermal protection and even damage to the driver.

The existing wall cutting machine can replace cumbersome manual work during the construction of reinforced concrete and brick buildings and concrete buildings. The existing wall cutting machine produces no flying dust and low noise and vibration during the construction operation, does not affect the strength of adjacent buildings or walls, and can keep the construction environment clean, thereby reducing labor intensity. Moreover, the work efficiency can be improved by 5 to 7 times. However, the existing wall cutting machine has a poor heat dissipation effect, and the operator cannot accurately determine whether the tensioning handwheel is adjusted to an appropriate strength during use, making the existing wall cutting machine less safe. Moreover, the power wheel cannot be adjusted automatically.

Therefore, it is necessary to propose a new solution to solve this problem.

### BRIEF SUMMARY OF THE INVENTION

In view of the defects in the prior art, an objective of the disclosure is to provide a long-life annular wall cutting machine.

The above technical objective of the disclosure is achieved by the following technical solution: A long-life annular wall cutting machine includes a housing and an annular saw blade fixing and protecting cover assembly. A power wheel is arranged in the annular saw blade fixing and protecting cover assembly, an annular saw blade is arranged in a middle of the power wheel, the power wheel and the annular saw blade abut against each other, one side of the power wheel is provided with an output shaft, an elastic member is mounted between the output shaft and the power wheel, the other side of the power wheel is provided with a pressing plate bolt, and a small pressing plate is mounted between the pressing plate bolt and the power wheel.

Further, the annular saw blade fixing and protecting cover assembly further includes a first saw blade holddown handwheel and a second saw blade holddown handwheel, and the first saw blade holddown handwheel and the second saw blade holddown handwheel are arranged on a same side wall of the annular saw blade fixing and protecting cover assembly.

Further, the annular saw blade fixing and protecting cover assembly further includes a water retaining plate, and the water retaining plate is arranged on a side of the annular saw blade fixing and protecting cover assembly close to the first saw blade holddown handwheel; and the annular saw blade fixing and protecting cover assembly further includes a tensioning handwheel, and the tensioning handwheel is arranged on the annular saw blade fixing and protecting cover assembly directly opposite the annular saw blade.

Further, the output shaft is provided with a gasket, the elastic member is a waved elastic pad, and the waved elastic pad is located between the gasket and the power wheel.

Further, wave fluctuations of the waved elastic pad are perpendicular to the annular saw blade.

Further, a taper fitting surface is arranged between the power wheel and the annular saw blade.

Further, a switch is further arranged on top of the housing, and one side of the switch is provided with a tensioning handwheel adjustment indicator light.

Further, the long-life annular wall cutting machine further includes a motor for driving the wall cutting machine, and the motor is driven by a motor driver.

Further, one end of the power wheel is further provided with a head shell, and two sides of the head shell are respectively provided with a first guide rail and a second guide rail.

Based on the above, the disclosure has the following beneficial effects:

1. With the design of the tensioning handwheel adjustment indicator light, the operator can accurately determine whether the tensioning handwheel is adjusted to an appropriate strength, thereby improving the safety performance of the wall cutting machine during use. If the contact strength is too small or too large, the indicator light of the brushless motor driver will turn yellow or red. If the strength is appropriate, the indicator light will turn green.

2. In this solution, the taper fitting surface is arranged between the power wheel and the annular saw blade. By rotating the tensioning handwheel, the contact strength between a taper surface of the annular saw blade and a taper surface of the power wheel can be adjusted, thereby realizing optimized adjustment of the power wheel.

### BRIEF DESCRIPTION OF THE DRAWINGS

FIG. 1 is a schematic structural view I of the disclosure;

FIG. 2 is a schematic structural view II of the disclosure;

FIG. 3 is a partial sectional view I of the disclosure; and

FIG. 4 is a partial sectional view II of the disclosure.

In the figures: 1, water cooling chamber; 2, annular saw blade fixing and protecting cover assembly; 3, driving box cooling fin; 4, motor driver; 5, power wheel; 6, annular saw blade; 7, taper fitting surface; 8, output shaft; 9, gasket; 10, waved elastic pad; 11, second guide rail; 12, pressing plate bolt; 13, small pressing plate; 14, water tube; 15, water inlet; 16, first cooling water outlet; 17, second cooling water outlet; 18, air inlet; 19, air outlet; 20, first saw blade holddown handwheel; 21, second saw blade holddown handwheel; 22, water retaining plate; 23, tensioning handwheel; 24, switch; 25, tensioning handwheel adjustment indicator light; 26, motor; 27, head shell; 28, first guide rail.

### DETAILED DESCRIPTION OF THE INVENTION

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

In order to better describe and illustrate the embodiments of this application, reference can be made to one or more accompanying drawings, but the additional details or examples used to describe the accompanying drawings should not be considered as limiting the scope of any of the inventions, currently described embodiments or preferred implementations of this application.

In the description of the disclosure, it should be noted that the orientation or positional relationship indicated by the terms “length”, “width”, “upper”, “lower”, “front”, “rear”, “left”, “right”, “top”, “bottom”, “inner”, “outer”, etc. is based on the orientation or positional relationship shown in the accompanying drawings, and it is only for the convenience of describing the disclosure and simplifying the description, rather than indicating or implying that the device or element referred to must have a particular orientation or be constructed and operated in a particular orientation, and therefore, should not be construed as a limitation of the disclosure.

Unless otherwise defined, all technical and scientific terms used herein have the same meaning as commonly understood by those skilled in the art of this application. The terms used in the specification of this application are only for the purpose of describing specific embodiments and are not intended to limit this application.

The disclosure will be described in detail in conjunction with the accompanying drawings and embodiments.

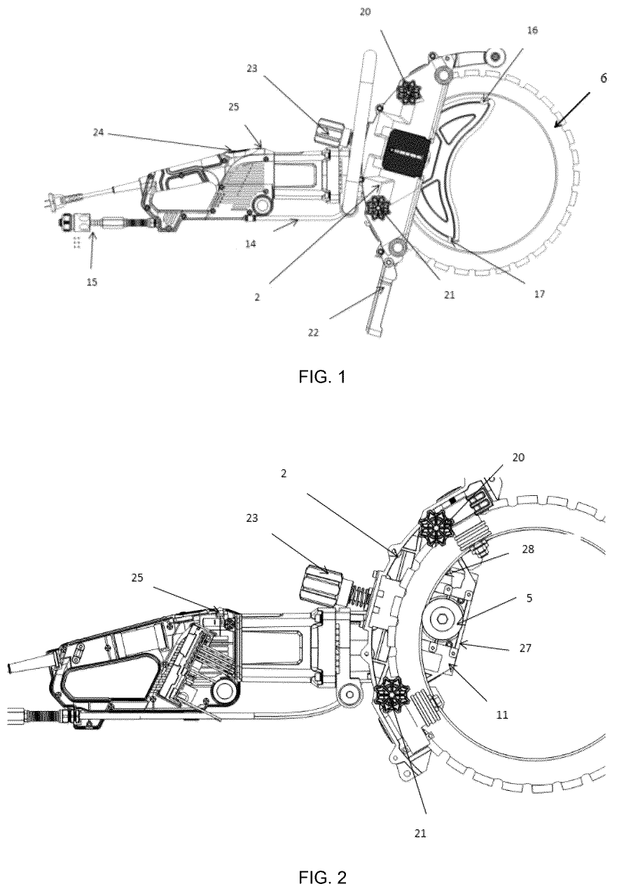

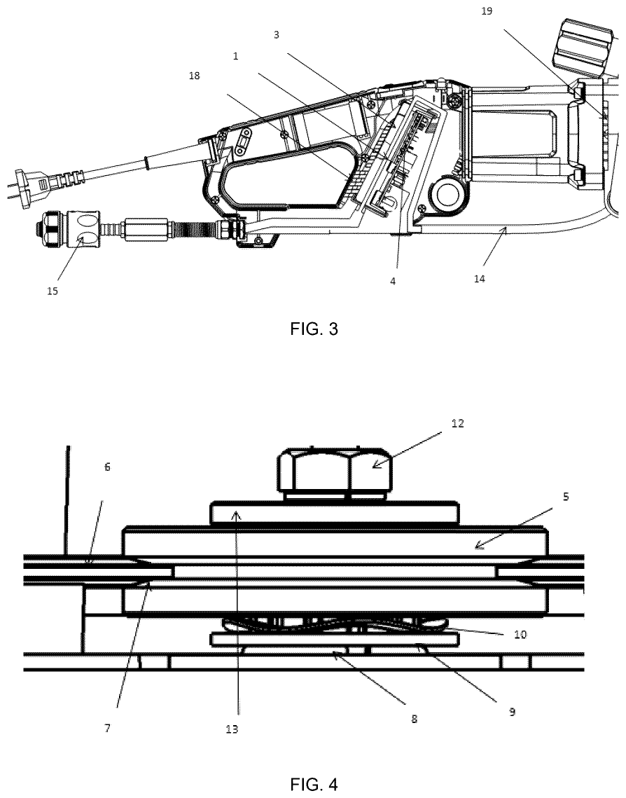

A long-life annular wall cutting machine, as shown in FIG. 1, FIG. 2 and FIG. 3, includes a housing, a water cooling chamber 1 and an annular saw blade fixing and protecting cover assembly 2. Driving box cooling fins 3 and a motor 26 driver 4 are mounted in the water cooling chamber 1. By providing the water cooling chamber 1, the water cooling chamber 1 can effectively reduce temperatures of the driving box cooling fins 3 and the motor 26 driver 4, thereby preventing overheating and prolonging the life of the wall cutting machine. Specifically, the long-life annular wall cutting machine further includes a motor 26 for driving the wall cutting machine and a water tube 14. The motor 26 is driven by the motor 26 driver 4, and a body of the water tube 14 passes through the water cooling chamber 1. One end of the water tube 14 is provided with a water inlet 15, and the other end of the water tube 14 is provided with a first cooling water outlet 16 and a second cooling water outlet 17. One side of the water cooling chamber 1 is provided with an air inlet 18, the air inlet 18 is directly opposite the driving box cooling fins 3, and the other side of the water cooling chamber 1 is provided with an air outlet 19. The motor 26 driver 4 can realize energy-saving operation of the motor 26. By optimizing operation parameters of the motor 26, such as reducing the voltage and improving the efficiency, the energy consumption of the motor 26 can be reduced, thereby realizing the goal of energy saving and emission reduction. Moreover, with the dual heat dissipation structure of the water cooling chamber 1 and air cooling, the heat dissipation capacity of heating elements of the driver is effectively improved. This design enables the machine to work continuously under heavy load, which prolongs the service life of the wall cutting machine and improves the operational safety. With the design of the water tube 14, cooling water can circulate. The cooling water enters via the water inlet 15, passes through the water cooling chamber 1, and is discharged from the first cooling water outlet and the second cooling water outlet 17. This design helps to maintain the flow and temperature control of the cooling water. Moreover, the design of the air inlet 18 and the air outlet 19 helps to simplify the maintenance and cleaning of the wall cutting machine.

As shown in FIG. 1, FIG. 2 and FIG. 4, the annular saw blade fixing and protecting cover assembly 2 is arranged on one side of the water cooling chamber 1. The annular saw blade fixing and protecting cover assembly 2 provides physical protection for the saw blade, prevents the saw blade from accidentally popping out or being damaged, and protects the operator from injury. Specifically, a power wheel 5 is arranged in the annular saw blade fixing and protecting cover assembly 2, an annular saw blade 6 is arranged in a middle of the power wheel 5, and a taper fitting surface 7 is arranged between the power wheel 5 and the annular saw blade 6. The taper fitting surface 7 between the power wheel 5 and the annular saw blade 6 can ensure stable transmission of power and keep the saw blade stable during high-speed rotation, thereby ensuring the cutting accuracy.

As shown in FIG. 1, FIG. 2 and FIG. 4, one side of the power wheel 5 is provided with an output shaft 8, and an elastic member is mounted between the output shaft and the power wheel. Specifically, the output shaft 8 is provided with a gasket 9, and a waved elastic pad 10 is mounted between the gasket 9 and the power wheel 5. Further, wave fluctuations of the waved elastic pad 10 are perpendicular to the annular saw blade 6. The gasket 9 on the output shaft 8 and the waved elastic pad 10 help to reduce the vibration and noise during power transmission, thereby providing a smoother operation experience, protecting the wall cutting machine and prolonging the service life of the long-life annular wall cutting machine. A tensioning handwheel adjustment indicator light 35 is arranged on top of the water cooling chamber 1. The tensioning handwheel adjustment indicator light 35 on top of the water cooling chamber 1 provides direct feedback. With the design of the tensioning handwheel adjustment indicator light 35, the operator can accurately determine whether the tensioning handwheel 23 is adjusted to an appropriate strength, thereby improving the safety performance of the wall cutting machine during use. If the contact strength is too small or too large, the indicator light of the brushless motor 26 driver 4 will turn yellow or red. If the strength is appropriate, the indicator light will turn green. The other side of the power wheel 5 is provided with a pressing plate bolt 12, and a small pressing plate 13 is mounted between the pressing plate bolt 12 and the power wheel 5. The design of the pressing plate bolt 12 and the small pressing plate 13 can ensure close fitting between the power wheel 5 and the saw blade and prevent the saw blade from sliding or shifting during high-speed rotation, thereby improving the cutting accuracy and efficiency. Moreover, with the design of the pressing plate bolt 12 and the small pressing plate 13, the holddown state of the power wheel 5 and the saw blade can be adjusted rapidly, which is convenient for the maintenance and replacement of the saw blade.

Further, as shown in FIG. 1 and FIG. 2, the annular saw blade fixing and protecting cover assembly 2 further includes a first saw blade holddown handwheel 20 and a second saw blade holddown handwheel 21, and the first saw blade holddown handwheel 20 and the second saw blade holddown handwheel 21 are arranged on a same side wall of the annular saw blade fixing and protecting cover assembly 2. With the above arrangement, the annular saw blade fixing and protecting cover assembly 2 and the motor 26 output shaft 8 can be assembled more easily. The arrangement of the first saw blade holddown handwheel 20 and the second saw blade holddown handwheel 21 allows the operator to adjust the holddown state of the saw blade rapidly, thereby improving the operating efficiency. Moreover, the annular saw blade fixing and protecting cover assembly and the output shaft are locked by a bolt, thereby making the assembly less complicated. The locking mechanism is simple in structure, and can realize rapid adjustment of the angle of the protecting cover. Thereby, the saw blade has wide applicability and can meet different cutting demands.

As shown in FIG. 1 and FIG. 2, the annular saw blade fixing and protecting cover assembly 2 further includes a water retaining plate 22 and a tensioning handwheel 23. The water retaining plate 22 is arranged on a side of the annular saw blade fixing and protecting cover assembly 2 close to the first saw blade holddown handwheel 20. The tensioning handwheel 23 is arranged on the annular saw blade fixing and protecting cover assembly 2 directly opposite the annular saw blade 6. The water retaining plate 22 arranged can prevent the coolant or water from entering the saw blade and driving components, thereby protecting the motor 26 and the driver from liquid erosion and prolonging the service life of the wall cutting machine. Moreover, the presence of the water retaining plate 22 can prevent the operator from being affected by the splashing coolant or water or from slipping during construction, thereby improving the safety of the construction site. With the arrangement of the tensioning handwheel 23, the operator can adjust the tension of the saw blade rapidly to make the saw blade meet different cutting demands, thereby making the operation more convenient and flexible. With the tensioning handwheel 23, the tension of the saw blade can be accurately controlled, which ensures the stability of the saw blade during high-speed rotation, thereby improving the cutting accuracy and quality.

As shown in FIG. 1 and FIG. 2, a switch 24 is further arranged on top of the housing, and one side of the switch 24 is provided with the tensioning handwheel adjustment indicator light 35. The tensioning handwheel adjustment indicator light 35 can accurately show the tensioning state of the saw blade, thereby avoiding the safety accidents caused by improper tensioning strength, and improving the safety performance of the wall cutting machine during use. Further, one end of the power wheel 5 is further provided with a head shell 27, and two sides of the head shell 27 are respectively provided with a first guide rail 28 and a second guide rail 11. With the arrangement of the first guide rail 28 and the second guide rail 11, the stability and straightness of the saw blade during cutting can be ensured, thereby improving the cutting accuracy; and the movement range of the saw blade can be limited, thereby reducing accident risks caused by improper operation, thereby improving the construction safety.

The above description is only preferred implementations of the disclosure, and the protection scope of the disclosure is not limited to the above embodiments. All the technical solutions falling under the idea of the disclosure belong to the protection scope of the disclosure. It should be noted that for a person of ordinary skill in the art, several improvements and modifications can be made without departing from the principle of the disclosure, and these improvements and modifications should also be regarded as the protection scope of the disclosure.

What is claimed is:

1. A long-life annular wall cutting machine, comprising a housing and an annular saw blade fixing and protecting cover assembly, wherein a power wheel is arranged in the annular saw blade fixing and protecting cover assembly, an annular saw blade is arranged in a middle of the power wheel, the power wheel and the annular saw blade abut against each other, one side of the power wheel is provided with an output shaft, an elastic member is mounted between the output shaft and the power wheel, the other side of the power wheel is provided with a pressing plate bolt, and a small pressing plate is mounted between the pressing plate bolt and the power wheel.

2. The long-life annular wall cutting machine according to claim 1, wherein the annular saw blade fixing and protecting cover assembly further comprises a first saw blade holddown handwheel and a second saw blade holddown handwheel, and the first saw blade holddown handwheel and the second saw blade holddown handwheel are arranged on a same side wall of the annular saw blade fixing and protecting cover assembly.

3. The long-life annular wall cutting machine according to claim 2, wherein the annular saw blade fixing and protecting cover assembly further comprises a water retaining plate, and the water retaining plate is arranged on a side of the annular saw blade fixing and protecting cover assembly close to the first saw blade holddown handwheel; and the annular saw blade fixing and protecting cover assembly further comprises a tensioning handwheel, and the tensioning handwheel is arranged on the annular saw blade fixing and protecting cover assembly directly opposite the annular saw blade.

4. The long-life annular wall cutting machine according to claim 3, wherein the output shaft is provided with a gasket, the elastic member is a waved elastic pad, and the waved elastic pad is located between the gasket and the power wheel.

5. The long-life annular wall cutting machine according to claim 4, wherein wave fluctuations of the waved elastic pad are perpendicular to the annular saw blade.

6. The long-life annular wall cutting machine according to claim 1, wherein a taper fitting surface is arranged between the power wheel and the annular saw blade.

7. The long-life annular wall cutting machine according to claim 1, wherein a switch is further arranged on top of the housing, and one side of the switch is provided with a tensioning handwheel adjustment indicator light.

8. The long-life annular wall cutting machine according to claim 1, further comprising a motor for driving the wall cutting machine, wherein the motor is driven by a motor driver.

9. The long-life annular wall cutting machine according to claim 1, one end of the power wheel is further provided with a head shell, and two sides of the head shell are respectively provided with a first guide rail and a second guide rail.
